(19) United States
(12) Patent Application Publication
(10) Pub. No.: US 2022/0410729 A1
(43) Pub. Date: Dec. 29, 2022

(54) ELECTROMAGNETIC AIRBORNE HYBRID VEHICLE

(71) Applicant: Mukesh Sharma, Surrey (CA)

(72) Inventor: Mukesh Sharma, Surrey (CA)

(21) Appl. No.: 17/446,991

(22) Filed: Sep. 7, 2021

(30) Foreign Application Priority Data
Jun. 25, 2021 (IN) 202111028531

(51) Int. Cl. B60L 50/90; B62D 21/17; B60L 50/60; B60L 8/00

(52) U.S. Cl. CPC B60L 50/90; B62D 21/17; B60L 50/60; B60L 8/003

(57) ABSTRACT

An electromagnetic vehicle chassis that is configured with an upper portion and a lower portion wherein the upper portion is movable to a second position and supported therein with an electromagnetic field. The vehicle of the present invention includes a frame having the upper portion movable so as to reduce the overall vehicle weight and as such require less propulsion force resulting in reduced energy consumption. The upper portion of the frame of the present invention is moved into its second position utilizing hydraulic cylinders. Electromagnets present on both the upper portion and lower portion maintain the upper portion in its second position. A battery compartment having a plurality of batteries is operably coupled to the lower portion of the frame. The body of the vehicle includes a plurality of photovoltaic cells electrically coupled to the plurality of batteries.

### PRIORITY UNDER 35 U.S.C. SECTION 119(E) & 37 C.F.R. SECTION 1.78

This nonprovisional application claims priority based upon the following prior Government of India Patent Application entitled: Electro Magnetic Air Borne Hybrid Vehicle, Application No.: 202111028531, CBR 22208 filed Jun. 25, 2021, in the name of Mukesh Sharma, which is hereby incorporated by reference for all purposes.

### FIELD OF THE INVENTION

The present invention relates generally to automobiles, more specifically but not by way of limitation, an electromagnetic airborne hybrid vehicle having a chassis that is configured to reduce the weight of the vehicle body utilizing electromagnetic repulsion between the chassis and the body in order to accomplish fuel consumption reduction of the vehicle during operation.

### BACKGROUND

Vehicle weight and engine power are two of the most important parameters that influence a vehicle's fuel consumption and carbon dioxide emissions. The weight of the average vehicle decreased from the mid-1970s to the mid-1980s and then increased dramatically until around 2005. In recent years, the average weight of the typical vehicle has stabilized. The average engine horsepower during this same time period has followed a similar trend, doubling since the early 1980s. If all other factors are equal, higher vehicle weight and faster acceleration result in increased fuel consumption. While automakers have continually developed more fuel efficient engines to offset current vehicle weights there is still a significant opportunity to lower fuel consumption. Gas and diesel prices are cyclical and with global demand increasing the average price for fuel has been steadily increasing. Since the mid-2000s, automakers have focused their attention on reducing fuel consumption while keeping vehicle weight and power more constant:

One estimate for fuel cost savings over a one hundred thousand kilometer range is anywhere from eighty dollars if ten kilograms is removed from the vehicle to an overwhelming eight thousand dollars of it could be possible to reduce a vehicle weight by one thousand kilograms. The latter has been a focus for pickup trucks and similar larger vehicles where many automakers have reduced the weight of these vehicles by using lighter materials for the frame while preserving structural integrity and safety. Still with the improvements made, there is significant opportunity to further achieve fuel consumption reduction through impacting vehicle weight.

Accordingly, there is a need for a vehicle chassis that is configured to reduce the weight of the body thereon by a significant amount through utilization of electromagnetic repulsion and hydraulic pistons so as to reduce fuel consumption of the vehicle.

### SUMMARY OF THE INVENTION

It is the object of the present invention to provide a vehicle chassis that is configured to be operably coupled to a vehicle body in a manner that provides reduction of fuel consumption for the vehicle wherein present invention includes a chassis structure having opposing pairs of lateral side members.

Another object of the present invention is to provide a vehicle chassis and body configuration that is operable to reduce fuel consumption during operation of the vehicle wherein the chassis of the present invention includes an upper portion and a lower portion.

A further object of the present invention is to provide a vehicle chassis that is configured to be operably coupled to a vehicle body in a manner that provides reduction of fuel consumption for the vehicle wherein upper portion and lower portion of the chassis each include electromagnetic blocks.

Still another object of the present invention is to provide a vehicle chassis and body configuration that is operable to reduce fuel consumption during operation of the vehicle wherein the lower portion of the chassis further includes hydraulic pistons.

An additional object of the present invention is to provide a vehicle chassis that is configured to be operably coupled to a vehicle body in a manner that provides reduction of fuel consumption for the vehicle wherein the body of the present invention includes multiple layers of photovoltaic cells.

Yet a further object of the present invention is to provide a vehicle chassis and body configuration that is operable to reduce fuel consumption during operation of the vehicle that further includes a battery compartment underneath the chassis.

Another object of the present invention is to provide a vehicle chassis that is configured to be operably coupled to a vehicle body in a manner that provides reduction of fuel consumption for the vehicle wherein the electromagnets on the upper and lower portion of the chassis are arranged to have the same poles adjacent each other so as to provide repulsion forces therebetween.

Still an additional object of the present invention is to provide a vehicle chassis and body configuration that is operable to reduce fuel consumption during operation of the vehicle wherein the hydraulic pistons of the lower portion of the chassis are configured to provide initial lift of the upper portion of the chassis.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a side diagrammatic view of the present invention; and

FIG. 2 is an external diagrammatic view of the present invention showing the photovoltaic cells; and

FIG. 3 is a side diagrammatic view of the battery box and portion of lower chassis; and

FIG. 4 is a top perspective view of an embodiment of the present invention; and

FIG. 5 is an end diagrammatic view of the chassis of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated an electromagnetic vehicle chassis 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to Figures submitted as a part hereof, the electromagnetic vehicle chassis 100 includes a chassis 5 having an upper portion 7 and a lower portion 9. The upper portion 7 is superposed the lower portion 9 and is manufactured to be of similar dimensions. The upper portion 7 includes support members 10, 11 that are longitudinal support frame members configured to be operably coupled to the body 95 of the vehicle 99 utilizing suitable techniques. The support members 10,11 are manufactured from a suitable material such as but not limited to metal beams and are contemplated to be provided in alternate sizes as needed depending upon the type of vehicle for which the electromagnetic vehicle chassis 100 is being utilized. Upper portion 7 has operably inserted thereinto a plurality of upper electromagnets 15. The upper electromagnets 15 are secured into the upper portion 7 utilizing suitable techniques. As will be discussed further herein , the upper electromagnets 15 are operably engaged with the lower electromagnets 40 in order to maintain the body 95 in its second position.

The upper portion 7 includes springs 20 secured to the ends of the support members 10, 11. The springs 20 are secured to the support members 10,11 at each end thereof utilizing suitable techniques such as but not limited to mechanical fasteners or welding. The springs 20 are configured to operably engage the vertical support members 31,32 of the lower support members 28,29 of the lower portion 9. The springs 20 are high tension metal springs that are configured to substantially inhibit any back and forth movement of the upper portion 7 when the body 95 is in its second position. The vertical support members 31,32 extend upward from the lower support members 28,29 creating a U-shape to the lower portion 9 which functions to captively secure the upper portion 7 subsequent the upper portion 7 being moved to its second position. Ensuing being moved to the second position, the upper portion 7 has movement thereof substantially inhibited via the springs 20. While springs 20 are illustrated and discussed herein as being operable to damper movement of the upper portion 7, it should be understood within the scope of the present invention that alternate elements could be employed in place of and/or in conjunction with the springs 20.

The lower portion 9 includes lower electromagnets 40. The lower electromagnets 40 are aligned with the upper electromagnets 15. The upper electromagnets 15 and lower electromagnets 40 function to move the upper portion 7 and as such the body 95 from a first position to a second position. In the first position the upper portion 7 and lower portion 9 are adjacent each other and as such the entire weight of the upper portion 7 and body 95 bears on the lower portion 9 creating a heavier weight bearing on the wheels and results in a requirement for a greater exertion by engine 98. The upper electromagnets 15 and lower electromagnets 40 are configured to have the same polarity. Having the same polarity creates an electromagnetic field, represented herein with circles 97. The electromagnetic field has sufficient force operable to maintain the upper portion 7 above the lower portion 9 in its second position such that there is a void therebetween. In this second position, the weight bearing on the lower portion 7 is significantly reduced and as such the energy exertion required by the engine 98 is substantially less thus resulting in reduced fuel consumption. It should be understood within the scope of the present invention that the upper portion 7 and lower portion 9 could employ various quantities of electromagnets in order to maintain the second position as described herein.

A plurality of hydraulic cylinders 50 are operably mounted to the lower portion 9 utilizing suitable durable techniques. The hydraulic cylinders 50 are conventional hydraulic cylinders having a piston that is operable to move in an upwards-downwards direction. The hydraulic cylinders 50 function to provide the initial movement of the upper portion 7 to its second position and ensuing being moved to its second position by the hydraulic cylinders 50, the upper electromagnets 15 and lower electromagnets 40 are activated and as such the electromagnetic field having the repelling forces due to the same polarity will provide the necessary force to maintain the upper portion 7 in its second position. It should be understood within the scope of the present invention that various quantities and sizes of hydraulic cylinders could be employed. Furthermore, it should be understood within the scope of the present invention that the hydraulic cylinders 50 are employed to return the upper portion 7 from its second position to its first position.

A plurality of batteries 55 are located in the battery compartment 56 and are configured to provide the necessary electrical power to operate the upper electromagnets 15 and lower electromagnets 40. The batteries 55 are conventional direct current batteries and it is contemplated within the scope of the present invention that various quantities and sizes of batteries 55 could be employed. It is further contemplated within the scope of the present invention that an engine battery 96 could be separately employed to provide the necessary electrical starting current for the engine 98. The battery compartment 56 includes hingedly attached cover 57 configured to provide access thereto. It should be understood within the scope of the present invention that the engine 98 could be any type of engine such as but not limited to a combustion engine, electric motor or hybrid.

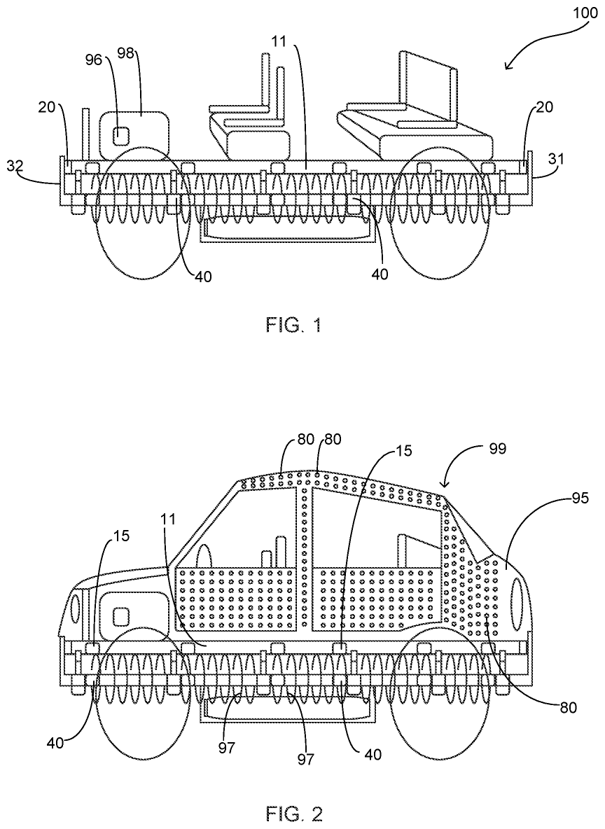

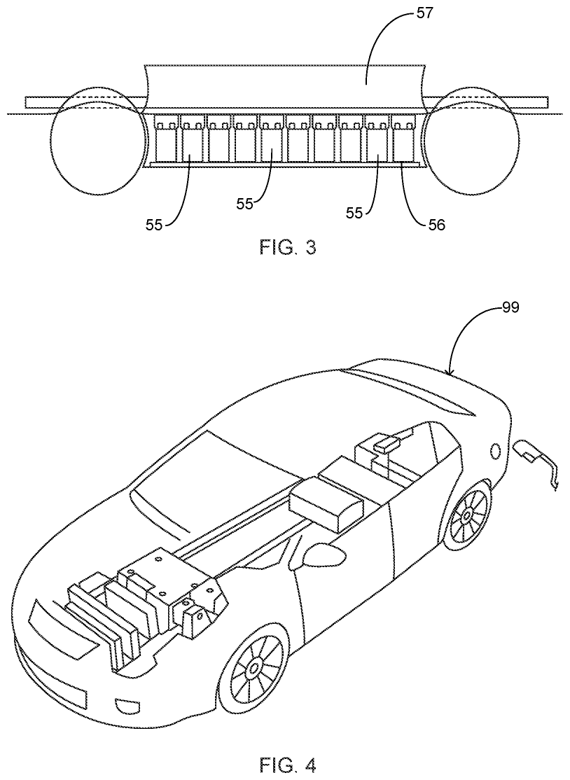

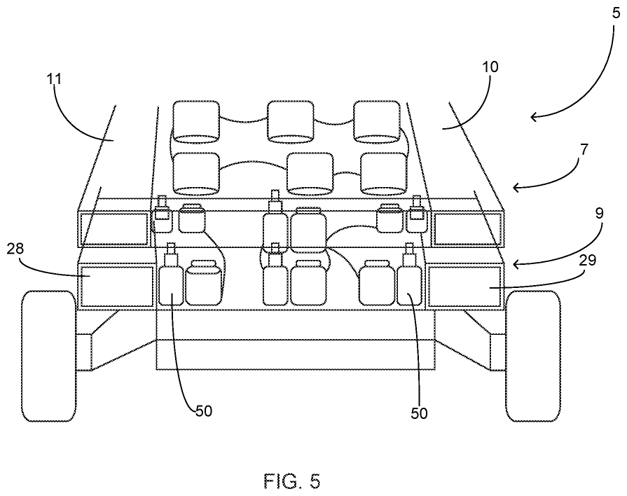

Referring in particular to FIG. 2, the electromagnetic vehicle chassis 100 includes a plurality of photovoltaic cells 80 located on the body 95. The photovoltaic cells 80 are dispersed substantially over the outer surface of the body 95 and are electrically coupled to batteries 55 so as to provide the necessary electrical current to maintain the required level of charge for the batteries 55. It is contemplated within the scope of the present invention that the body 95 would have a first metal layer and a second metal layer for bonding of the photovoltaic cells 80 thereto utilizing suitable durable techniques such as mechanical fasteners, chemical adhesion or welding. It is further contemplated within the scope of the present invention that the photovoltaic cells 80 could be crystalline solar cells or thin film solar cells. While not particularly illustrated herein, a protective layer could be provided over the photovoltaic cells 80 wherein the protective layer is transparent so as to permit exposure to sunlight. Additionally, it is further contemplated within the scope of the present invention that a fourth layer could be added to the body 95 wherein the fourth layer would be provided to cover the photovoltaic cells 80 during periods on non-use or other desired times.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A vehicle having an electromagnetic chassis operable to provide reduced fuel consumption wherein the vehicle comprises:
a chassis, said chassis having a lower portion and an upper portion, said lower portion and said upper portion being operably coupled, said lower portion and said upper portion having support members in axial alignment, said upper portion being movable intermediate a first position and a second position, said upper portion being adjacent said lower portion in said first position;
a plurality of hydraulic cylinders, said hydraulic cylinders being operably coupled to said lower portion of said chassis, said hydraulic cylinders configured to move said upper portion into said second position;
a plurality of electromagnets, said plurality of electromagnets being mounted in said upper portion and said lower portion of said chassis, said plurality of electromagnets being configured with identical polarities so as to repel against one another; and
a body, said body being secured to said upper portion, said body having at least one door and a plurality of panels defining a passenger compartment.

2. The vehicle having an electromagnetic chassis operable to provide reduced fuel consumption as recited in claim 1, wherein said lower portion further includes a first vertical support member and a second vertical support member, said first vertical support member and said second vertical support member being located at opposing ends of said lower portion, said first vertical support member and said second vertical support member extending upward from said lower portion and being perpendicular thereto.

3. The vehicle having an electromagnetic chassis operable to provide reduced fuel consumption as recited in claim 2, wherein said upper portion of said chassis is disposed within said first vertical support member and said second vertical support member.

4. The vehicle having an electromagnetic chassis operable to provide reduced fuel consumption as recited in claim 3, wherein said plurality of electromagnets are arranged in vertical axial alignment.

5. The vehicle having an electromagnetic chassis operable to provide reduced fuel consumption as recited in claim 4, wherein said body further includes a plurality of photovoltaic cells disposed on an outer surface thereof.

6. The vehicle having an electromagnetic chassis operable to provide reduced fuel consumption as recited in claim 5, wherein said upper portion further includes a first spring and a second spring secured to opposing ends thereof, said first spring and said second spring configured to operably engage said first vertical support member and said second vertical support member.

7. The vehicle having an electromagnetic chassis operable to provide reduced fuel consumption as recited in claim 6, and further including a plurality of batteries, said plurality of batteries being electrically coupled to said photovoltaic cells and said plurality of electromagnets, said plurality of batteries being stored in a battery compartment secured to said lower portion of said chassis.

8. A electromagnetic chassis for a vehicle operable to provide reduced fuel consumption wherein the electromagnetic chassis comprises:
a chassis, said chassis having a lower portion and an upper portion, said lower portion and said upper portion being operably coupled, said lower portion including support members, said upper portion being comprised of support members, said upper portion having a first end and a second end, said lower portion having a first end and a second end, said upper portion being movable intermediate a first position and a second position, said upper portion being adjacent said lower portion in said first position, said upper portion being moved away from said lower portion so as to create a void therebetween in said second position;
a plurality of hydraulic cylinders, said hydraulic cylinders being operably coupled to said lower portion of said chassis, said hydraulic cylinders being configured to operably engage said upper portion, said plurality of hydraulic cylinders operable to move said upper portion to said second position;
a plurality of electromagnets, said plurality of electromagnets being mounted in said upper portion and said lower portion of said chassis, said plurality of electromagnets being arranged in axial alignment, said plurality of electromagnets being configured with an identical polarity, said plurality of electromagnets operable to produce an electromagnetic field operable to maintain said upper portion in said second position; and
a body, said body being secured to said upper portion, said body having at least one door and a plurality of panels defining a passenger compartment.

9. The electromagnetic chassis for a vehicle as recited in claim 8, wherein said lower portion of said chassis is U-shaped having a first vertical support member and a second vertical support member at opposing ends thereof, said first vertical support member and said second vertical support member captively securing said upper portion.

10. The electromagnetic chassis for a vehicle as recited in claim 9, wherein said body further includes a plurality of photovoltaic cells disposed on an outer surface thereof.

11. The electromagnetic chassis for a vehicle as recited in claim 10, wherein said upper portion further includes a first spring and a second spring secured to opposing ends thereof, said first spring and said second spring configured to operably engage said first vertical support member and said second vertical support member.

12. The electromagnetic chassis for a vehicle as recited in claim 11, and further including a plurality of batteries, said plurality of batteries being electrically coupled to said photovoltaic cells and said plurality of electromagnets, said plurality of batteries being stored in a battery compartment secured to said lower portion of said chassis.

13. The electromagnetic chassis for a vehicle as recited in claim 12, and further including an engine, said engine being secured to said chassis.

14. The electromagnetic chassis for a vehicle as recited in claim 13, and further including a protective layer, said protective layer being removably disposed over said plurality of said photovoltaic cells.
